(19) United States
(12) Patent Application Publication
(10) Pub. No.: US 2008/0281660 A1
(43) Pub. Date: Nov. 13, 2008

(54) System, Method and Apparatus for Outsourcing Management of One or More Technology Infrastructures

(75) Inventors: Ram Sajja, Plano, TX (US); George T. Gundling, Plano, TX (US)

Correspondence Address: CHALKER FLORES, LLP, 2711 LBJ FRWY, Suite 1036, DALLAS, TX, 75234, US

(73) Assignee: SYSTEM SERVICES, INC., Plano, TX (US)

(21) Appl. No.: 11/747,910

(22) Filed: May 13, 2007

(51) Int. Cl. G06Q 10/00; G06F 9/46

(52) U.S. Cl. 705/8; 705/1

(57) ABSTRACT

The present invention provides a system, method and apparatus for outsourcing management of one or more technology infrastructures having two or more technology elements by collecting data from the technology elements using one or more interface rules and a metadata dictionary stored in a data repository wherein each technology infrastructure belongs to a separate entity and is remotely located with respect to a management entity, analyzing the collected data and initiating one or more automated processes based on the analyzed data, one or more thresholds and one or more management rules stored in the data repository. Note that this invention can be implemented using a computer program embodied on a computer readable medium wherein the steps are preformed by one or more code segments.

### CROSS-REFERENCE TO RELATED APPLICATIONS

This patent application is related to U.S. patent application Ser. No. ______ filed on May 13, 2007 and entitled “System; Method and Apparatus for Managing a Technology Infrastructure” which is hereby incorporated by reference in its entirety.

### FIELD OF THE INVENTION

The present invention relates generally to the field of computer systems and, more particularly, to a system, method and apparatus for outsourcing management of one or more technology infrastructures.

### BACKGROUND OF THE INVENTION

Regardless of size, businesses rely on technology more today than ever before. Managing the many technologies required to compete in today's competitive climate has become increasingly more complex and expensive. For example, security and virus threats have become more complex and frequent. Moreover, many businesses are required to keep and/or submit detailed information technology related logs to auditors, regulators, governmental bodies and others. Business technology infrastructures are often unique or highly customized. In addition, computer and network technology advances require information technology personnel to be knowledgeable on legacy systems, existing systems and new systems. Despite all of these obligations, responsibilities and pressures, many businesses are reducing the budgets and personnel of their information technology departments.

A company's technology infrastructure typically includes the following layers: business processes; business applications; backup/archival/monitoring/utilities; databases; operating systems; networks; and hardware. Business is driving information technology departments to support many technologies for each one of these layers. Moreover, each one of these technologies requires expertise and usually demands 24×7×365 availability. Information technology departments have not had their own comprehensive functional solution for effective management and communications.

Accordingly there is a need for a system, method and apparatus for outsourcing the management of one or more technology infrastructures that is adaptive, comprehensive and effective.

### SUMMARY OF THE INVENTION

The present invention provides a system, method and apparatus for outsourcing the management of one or more technology infrastructures that is adaptive, comprehensive and effective. Implementation of the present invention can benefit small businesses, large businesses, local environments, distributed environments, single technology infrastructures, multiple technology infrastructures, and everything in between. For example, the present invention supports the following technologies: Microsoft Windows, AIX, Solaris, HP-UX, Linux, AS/400, Novell, Exchange, Oracle databases, SQL Server, WINS, Domino, DHCP, IIS, DNS, Alcatel, Nortel, Cisco, etc. Moreover, the present invention provides one or more features: automation; visibility; business intelligence; remote management; and ease of use.

Automated repetitive processes can provide total environment management for all platforms and technologies (e.g., servers, databases, network devices, applications, critical processes, etc.), flexible threshold-based alerting, problem escalation, device specific performance analyzer, customized device level management, and integration into existing environments. The present invention can provide total environment visibility, web-based state of the environment scoreboard, service level reporting, system utilization and performance trends, current and historical data warehouse, customizable web-based reporting, and secure hierarchical access levels. Business intelligence improves communications within the business, daily state of the environment reporting, proactive outage prevention, performance trends, historical analysis, capacity planning, change impact analysis and root cause resolution. The present invention is easy to use because it can provide a single solution for all platforms, tailored to an entity's environment, rapid implementation, device-based tiered pricing, and immediate business benefits.

One embodiment of the present invention provides a method for outsourcing management of one or more technology infrastructures having two or more technology elements by collecting data from the technology elements using one or more interface rules and a metadata dictionary stored in a data repository wherein each technology infrastructure belongs to a separate entity and is remotely located with respect to a management entity, analyzing the collected data and initiating one or more automated processes based on the analyzed data, one or more thresholds and one or more management rules stored in the data repository. Note that this method can be implemented using a computer program embodied on a computer readable medium wherein the steps are preformed by one or more code segments.

Another embodiment of the present invention provides an apparatus for outsourcing management of one or more technology infrastructures having two or more technology elements. The apparatus includes a data repository, a communications interface and one or more processors communicably coupled to the data repository and the communications interface. The data repository has one or more rules for managing and interfacing with two or more technology elements and a metadata dictionary. The one or more processors are configured to collect data from the technology elements via the communications interface using the interface rules and metadata dictionary, analyze the collected data, and initiate one or more automated processes based on the analyzed data, one or more thresholds and the management rules. Each technology infrastructure belongs to a separate entity and is remotely located with respect to the management entity.

Yet another embodiment of the present invention also provides a system for outsourcing management of one or more technology infrastructures. The system includes the one or more technology infrastructures, a communications network and a server communicably coupled to the two or more technology elements via the communications network. Each technology infrastructure has two or more technology elements belonging to a separate entity and is remotely located with respect to a management entity. The server comprises a data repository, a communications interface and one or more processors communicably coupled to the data repository and the communications interface. The data repository has one or more rules for managing and interfacing with two or more technology elements and a metadata dictionary. The one or more processors are configured to collect data from the technology elements via the communications interface using the interface rules and the metadata dictionary, analyze the collected data, and initiate one or more automated processes based on the analyzed data, one or more thresholds and the management rules.

The present invention is described in detail below with reference to the accompanying drawings.

### BRIEF DESCRIPTION OF THE DRAWINGS

The above and further advantages of the invention may be better understood by referring to the following description in conjunction with the accompanying drawings, in which:

FIG. 1 is a block diagram of an apparatus for managing a technology infrastructure in accordance with a first embodiment of the present invention;

FIG. 2 is a block diagram of an apparatus for managing a technology infrastructure in accordance with a second embodiment of the present invention;

FIG. 3 is a block diagram of an apparatus for managing a technology infrastructure in accordance with a third embodiment of the present invention;

FIG. 4 is a flow chart of a method for managing a technology infrastructure in accordance with a fourth embodiment of the present invention;

FIG. 5 is a flow chart of a method for managing a technology infrastructure in accordance with a fifth embodiment of the present invention;

FIG. 6 is a flow chart of a method for managing a technology infrastructure in accordance with a sixth embodiment of the present invention;

FIG. 7 is a block diagram of a system for managing a technology infrastructure in accordance with a seventh embodiment of the present invention;

FIG. 8 is a flow chart of a method for outsourcing management of one or more technology infrastructures in accordance with an eighth embodiment of the present invention;

FIG. 9 is a flow chart of a method for outsourcing management of one or more technology infrastructures in accordance with a ninth embodiment of the present invention;

FIG. 10 is a screen shot of a login screen of a computer program for managing a technology infrastructure in accordance with a tenth embodiment of the present invention;

FIG. 11 is a screen shot of an enterprise scoreboard screen of a computer program for managing a technology infrastructure in accordance with the tenth embodiment of the present invention;

FIG. 12 is a screen shot of a first report screen of a computer program for managing a technology infrastructure in accordance with the tenth embodiment of the present invention;

FIGS. 13-18 are a screen shots of various report screens of a computer program for managing a technology infrastructure in accordance with the tenth embodiment of the present invention;

FIG. 19 is a screen shot of a eighth report screen of a computer program for managing a technology infrastructure in accordance with the tenth embodiment of the present invention; and

FIG. 20 is a screen shot of a ninth report screen of a computer program for managing a technology infrastructure in accordance with the tenth embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention. The discussion herein relates primarily to the configuration, monitoring and troubleshooting of computer networks, but it will be understood that the concepts of the present invention are applicable to any type of network having interconnected devices.

The present invention provides a system, method and apparatus for managing the technology infrastructure of an organization that is adaptive, comprehensive and effective. Implementation of the present invention can benefit small businesses, large businesses, local environments, distributed environments, single technology infrastructures, multiple technology infrastructures, and everything in between. For example, the present invention supports the following technologies: Microsoft Windows, AIX, Solaris, HP-UX, Linux, AS/400, Novell, Exchange, Oracle databases, SQL Server, WINS, Domino, DHCP, IIS, DNS, Alcatel, Nortel, Cisco, etc. Moreover, the present invention provides one or more features: automation; visibility; business intelligence; remote management; and ease of use.

Automated repetitive processes can provide total environment management for all platforms and technologies (e.g., servers, databases, network devices, applications, critical processes, etc.), flexible threshold-based alerting, problem escalation, device specific performance analyzer, customized device level management, and integration into existing environments. The present invention can provide total environment visibility, web-based state of the environment scoreboard, service level reporting, system utilization and performance trends, current and historical data warehouse, customizable web-based reporting, and secure hierarchical access levels. Business intelligence improves communications within the business, daily state of the environment reporting, proactive outage prevention, performance trends, historical analysis, capacity planning, change impact analysis and root cause resolution. The present invention is easy to use because it can provide a single solution for all platforms, tailored to an entity's environment, rapid implementation, device-based tiered pricing, and immediate business benefits.

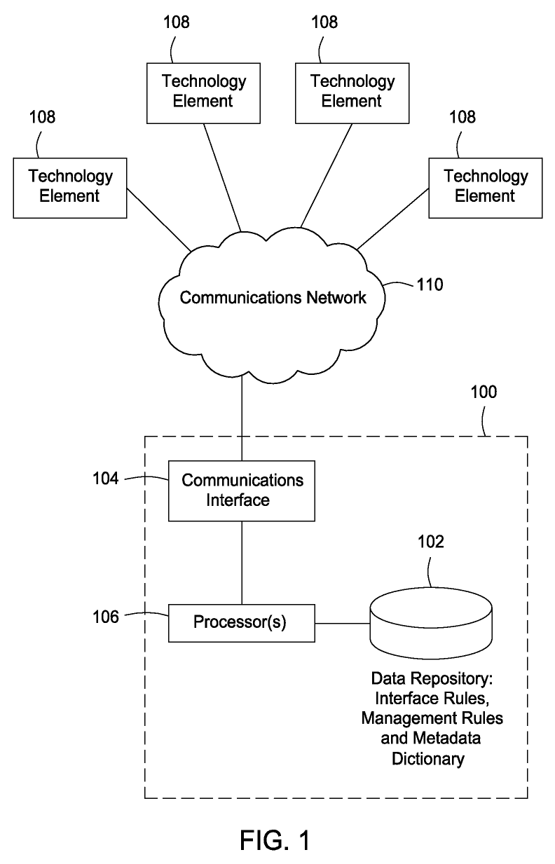

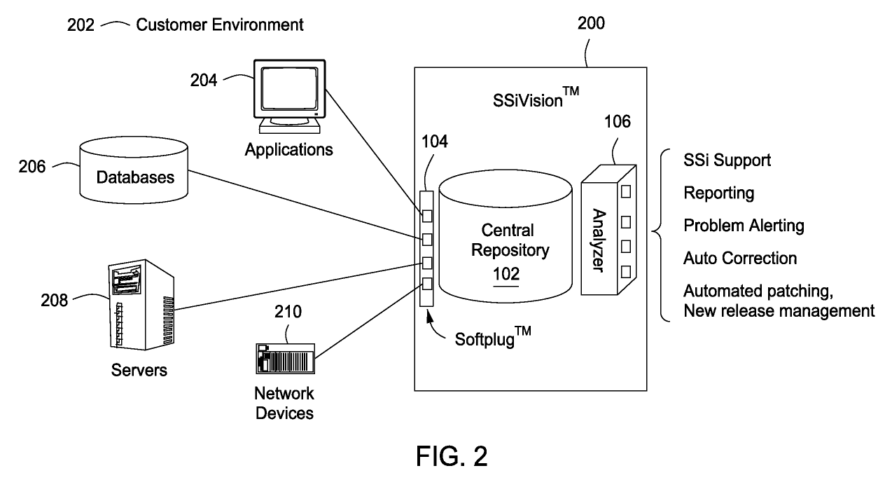

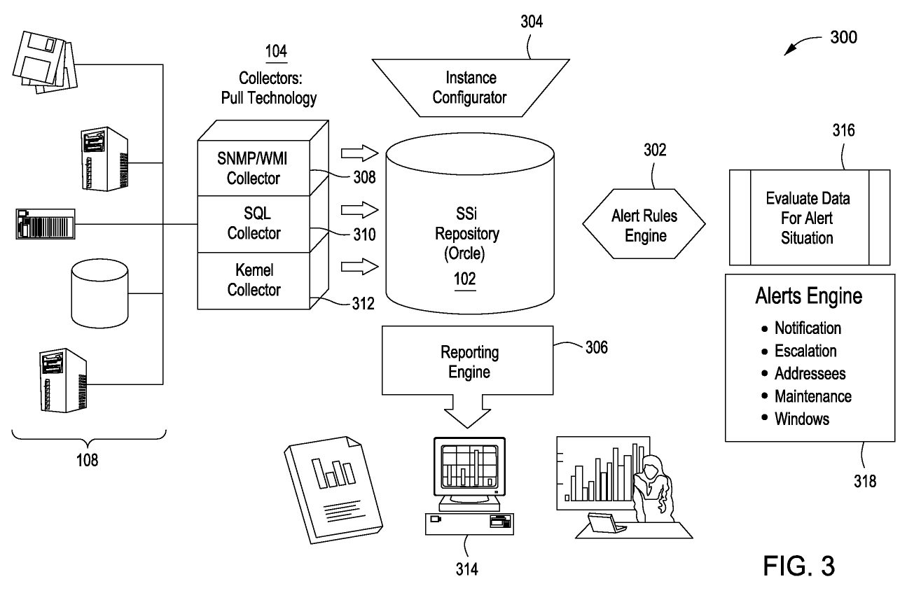

Now referring to FIG. 1, a block diagram of an apparatus 100 for managing a technology infrastructure in accordance with a first embodiment of the present invention is shown. The apparatus 100 includes a data repository 102, a communications interface 104 (e.g., a SoftPlug (FIG. 2), one or more collectors (FIG. 3), a network card, etc.) and one or more processors 106 (e.g., Analyzer (FIG. 2), computer, etc.) communicably coupled to the data repository 102 and the communications interface 104. The data repository 102 has one or more rules for managing and interfacing with two or more technology elements 108 and a metadata dictionary. The one or more processors 106 are configured to collect data from the technology elements 108 via the communications interface 104 using the interface rules and the metadata dictionary, analyze the collected data, and initiate one or more automated processes based on the analyzed data, one or more thresholds and the management rules. The technology elements 108 and the communications interface 104 are communicably coupled to one another via a communications network 110. The apparatus 100 may also include additional interfaces (not shown), such as an input application program interface, an output application program interface, or a combined input/output application program interface.

The data repository 102 can be used to define key relationships between the technology elements 108 for successfully completing a business process, customer mapping of the technology elements 108, functional relationships of the technology elements 108, key performance indicators, auto-correction rules based on event logic, escalation rules or a combination thereof. In addition, the data repository 102 can include a unique device identification, a device name, a device type and a device data model for each technology element 108. The data repository 102, the analyzed data, the thresholds, the management rules, the interface rules or a combination thereof can be accessible via a web-based browser. The thresholds can be defined based on one or more characteristics of the technology elements 108.

The technology elements may include any type of hardware, software, process or database whether currently known or developed in the future. For example, the technology elements may include one or more computers, one or more laptops, one or more workstations, one or more processors, one or more servers, one or more communication devices, one or more network devices, one or more switches/routers, one or more security devices, one or more applications, one or more business processes, one or more utilities, one or more data backup/recovery processes or devices, one or more databases, one or more operating systems or a combination thereof. Moreover, technology element 108 may also be a set of interconnected technology elements or sub-elements that collectively use a single interface to the communications network 110. For example, a single computer may include several technology elements 108: computer hardware; one or more applications, processes, programs or utilities running on the computer; one or more databases; or one or more peripheral devices (e.g., printer, scanner, etc.).

As will be further described below, the technology elements can be two or more remotely located systems that are owned/operated by the same or different entities. In other words, the apparatus 100 can be plugged into each customer environment as well as an integrated automated technology management solution that delivers the required capabilities to manage all customers remotely from a central site. Accordingly, apparatus 100 can be used for outsourcing management of one or more technology infrastructures having two or more technology elements. For example, each technology infrastructure can belong to a separate entity and be remotely located with respect to a management entity. The management entity manages the technology infrastructure at a price that is less than the cost for the separate entity to manage the technology infrastructure. The price can be less than or equal to 70% of the cost (e.g. 40% to 70%). Note that the management entity can mange only a portion of the technology infrastructure (e.g., one or more legacy technology elements, one or more splintered technology elements, one or more specialized technology elements, one or more small-scale technology element or a combination thereof). Using the apparatus 100 in this way can improve the reliability and performance of the technology infrastructure, reduce the cost to the separate entity, reduce the number of employees required by the separate entity or a combination thereof.

The processors 106 can be configured to dynamically configure the technology elements 108 based on the interface rules, the metadata dictionary, the management rules or a combination thereof. The automated processes can be correcting the technology elements 108, troubleshooting the technology elements 108, detecting and interfacing with one or more new technology elements 108, detecting one or more changes in the technology elements 108, correcting detected defects, correcting detected problems, reporting alerts, reporting warnings, reporting errors, reporting statistics, reporting status of the technology elements 108, generating customer specific reports, maintaining the technology elements 108, updating the technology elements, providing one or more notifications, creating one or more audit trails, creating one or more security logs, monitoring security of the technology elements 108 or a combination thereof.

Referring now to FIG. 2, a block diagram of an apparatus 200 for managing a technology infrastructure (Customer Environment 202) in accordance with a second embodiment of the present invention is shown. The Customer Environment 202 includes various technology elements 108: applications 204, databases 206, servers 208 and network devices 210. The apparatus 200 includes a central repository 102, a SoftPlug 104, and an Analyzer 106 communicably coupled to the central repository 102 and the SoftPlug 104. The central repository 102 has one or more rules for managing and interfacing with the technology elements 108 (applications 204, databases 206, servers 208 and network devices 210) within the Customer Environment 202 and a metadata dictionary. The SoftPlug 104 uses plug-and-play technology to quickly implement all technology elements 108 to be managed. The Analyzer 106 is configured to collect data from the technology elements 108 via the SoftPlug 104 using the interface rules and the metadata dictionary, analyze the collected data, and initiate one or more automated processes based on the analyzed data, one or more thresholds and the management rules. The Analyzer 106 provides support, reporting, problem alerting, auto-correction and automated patching, and new release management. The apparatus 200 may also include additional interfaces (not shown), such as an input application program interface, an output application program interface, or a combined input/output application program interface. Moreover, apparatus 200 can be used for outsourcing management of one or more technology infrastructures having two or more technology elements.

The central repository 102 stores: a Softplug link which holds the rules to how the apparatus 200 communicates with the specific technology; the key relationships between technology devices 108, such as a server being dependent upon successfully completing a critical business process; the customer profile mapping all devices associated with the customer; functional relationships of the technical hierarchy (e.g. Finance); key performance indicators continually updated and accessible by the reporting subsystem; the analyzer engine that continually evaluates key indicators and initiates alerts and auto-correction processes; the auto-correction rules determining corrective action to be taken based on the event logic; and the alerting and escalation rules.

The dynamic features of the apparatus 200 enable remote management of all customers with many diverse technologies making up their infrastructure environment. The dynamic nature enables: no programming required to set up a new customer; no programming required to set up a new technology to be managed (new server, database, etc.); auto-discovery and configuration of a customer environment; auto-setup of customer specific alert generation; auto-setup of technology specific alert generation; out of the box reporting subsystem (for each customer); out of the box reporting system providing visibility to all customers; automated correction to resolve problem conditions; minimal work required to implement new technologies to be managed; and flexibility for customizations to deliver business process automation. These dynamic capabilities are incorporated into the central repository 102, which stores the details for each managed technology. The apparatus 200 can provide intelligent alerting, reporting and proactive review. Intelligent alerting includes database administration, system administration, application analysts and network support. Reporting includes current state scoreboard, ad hoc history access, alert history and business intelligence. Proactive review includes capacity planning, consolidation planning, change impact analysis and root cause analysis.

Now referring to FIG. 3, a block diagram of an apparatus 300 for managing a technology infrastructure in accordance with a third embodiment of the present invention is shown. The apparatus 300 includes a repository 102, one or more collectors 104 (communications interfaces) and an alerts rule engine 302, instance configurator 304 and reporting engine 306 (collectively processors 106) communicably coupled to the repository 102. The repository 102 has one or more rules for managing and interfacing with two or more technology elements 108 and a metadata dictionary. The apparatus 300 can be implemented in a server configuration in which the specifications are based on the parameters of the environment being managed. Although Linux is preferred, other operating system platforms can be used. In one example, the software running on the server 300 is written using Java, Tomcat and Perl. Oracle is used as the standard database (repository 102).

The apparatus 300 collects data from a wide number of technology elements 108 using one or more collectors 104, such as a WMI collector 308 for managing Microsoft Windows environments, a SNMP collector 308 for managing network devices, a SQL collector 310 for accessing database performance statistics and a Kernel collector 312 using the native O/S commands to retrieve performance data in Unix and Linux environments. All performance statistics captured by the collectors 104 are loaded into the repository 102 with data retention set to provide access to both current and historical performance information. Metadata is also contained in the repository 102. This metadata 102 is the foundation for the dynamic nature of present invention and contains all of the rules for managing technologies and customers.

The instance configurator 304 enables all technology elements 108 being managed by the server 300 to be dynamically configured based on the metadata rules for manage the specific devices 108. New instances are added using the following tables:

| | SNMP | | | |
|---|---|---|---|---|
| Table Name | Based | Oracle | System | Applications |
| Instance Name | Yes | Yes | Yes | Yes |
| (Ssi_instances) | | | | |
| Instance Details | Yes | Yes | Yes | Yes |
| (Ssi_instance_groups) | | | | |
| Modules Needed | Yes | Yes | Yes | Yes |
| (Ssi_job_scheduler) | | | | |
| Any New Pager Info | Yes | Yes | Yes | Yes |
| (Ssi_alert_pagers) | | | | |
| Paging Hours | Yes | Yes | Yes | Yes |
| (Ssi_alert_pager_schedules) | | | | |
| Track Alerts | Yes | Yes | Yes | Yes |
| (Ssi_alert_pager_tracking) | | | | |
| Alert Thresholds | Yes | Yes | Yes | Yes |
| (Ssi_alert_rules) | | | | |
| Escalation Path | Yes | Yes | Yes | Yes |
| (Ssi_alert_escalations) | | | | |
| Config Files | No | No | Yes | Yes |
| Edit Config files on the | | | | |
| system | | | | |
| Connection | No | Yes | Yes | Yes |
| Schedule | Yes | Yes | Yes | Yes |
| Create dbms_job | | | | |

The Metadata maintenance screens include the following tables:
SSI_CLIENTS. This is the first table to filled in.
SSI INSTANCE_OS. This table has all the different platforms supported. No dependencies.
SSI_INSTANCE_GROUPS. This table groups different instances together. No dependencies.
SSI_OID_DEFINITIONS. This table has the WMI/SNMP strings. No dependencies.
SSI_TARGET_TYPES. No dependencies
SSI_MODULES. Tied to ssi_job_scheduler. Every UNIQUE module_name in ssi_job_scheduler will have a entry in this table.
SSI_PARAMETERS_LOOKUP. This table is used for Oracle database parameters lookup. No dependencies.
SSI_RECEIVER. Depends on the ssi_alert_definitions, and user_tables table. Join these three tables and define the alert_message and tie that to a table. In other words, alert_id should be translated and displayed as alert_message and table_name is picked from user_tables by running select table_name from user_tables query.
SSI_WEB_REPORTS. Depends on ssi_instance_groups table. Join these two tables and display group_name instance of report_type column.
SSI_PDF_REPORTS. No dependencies.
SSI_COLLECTION_NAMES. This is a table for PDF reporting. No dependencies.
SSI_REPORT_COLLECTIONS. Tied to ssi_pdf reports and ssi_collection_names.
   This is used for PDF reports. Display report name greyed out.
SSI_REPORT_DEFINITIONS. This is for the PDF reports.
SSI_REPORTS. No dependencies
SSI_SECTIONS. No dependencies
SSI_REPORT_SECTIONS. Depends on ssi_reports and ssi_sections table. Join these two tables.
SSI_WEB_REPORT_SECTIONS.
SSI_WEB_USERS. No dependencies.

The configuration writer screens include the following tables:
SSI_CONF_FILE_TYPES. This table is needed if the configuration writer is used.
   No dependencies.
SSI_CONF_FILES. Tied to ssi_instances and ssi_conf_file_types.
SSI_CONF_FILE_SOURCE. Tied to ssi_instances, ssi_alert_definitions, ssi_conf_file_types.

Alert maintenance screens include the following tables:
SSI_ALERT_DEFINITIONS. This table is the parent table for alerts maintenance section.
SSI_ALERT_PAGERS. This table is a parent table for alert pagers.

Instance maintenance screens (Add/Modify/Delete) include the following tables:
SSI_INSTANCES. This table is the parent table that needs to be filled when adding a new instance. The only dependency for this table is ssi_clients.
SSI_INSTANCE_DETAIL. This table depends on ssi_instances table and uses instance_name instead of instance_id by joining the two tables.
SSI_ALERT_ESCALATIONS. To populate this table a entry should exist in ssi_instances, ssi_alert_pagers, ssi_alert_definitions. Join these tables and Display instance_name, pager_contact, and alert_message instead of instance_id, pager_id and alert_id respectively.
SSI_ALERT_PAGER_SCHEDULES. To populate this table, a entry should exist in ssi_instances and ssi_alert pagers tables. Join ssi_instances, ssi_alert_pagers and this table and display instance_name and alert_message instead of the instance_id and alert_id respectively.

SSI_ALERT_RULES. Depends on ssi_instances, ssi_alert_definitions tables. Join these three tables and display instance_name, alert_message instead of instance_id and alert_id.
SSI_ALERT_TRACKING. Depends on ssi_instances, ssi_alert_definitions tables. Join these three tables and display instance_name, alert_message instead of instance_id and alert_id.
SSI_JOB_SCHEDULER. Tied to ssi_instances, ssi_oid_definitions and ssi_target_types.
SSI_DISTRIBUTION_LIST. This table is needed for the distribution of reports and is tied to instance_id from ssi_instances and collection id from ssi_collection_names.
SSI_REPORT_INSTANCES. Tied to ssi_collection_names and ssi_instances. This is used for PDF reports. Display instance_name instead of instance_id and also display collection_names.
SSI_WEB_ACCESS_INSTANCES. Tied to ssi_instances, ssi_web users, display user_name and instance_name.
SSI_WEB_ACCESS_REPORTS. Tied to ssi_web reports, ssi_web_users, display user_name and report name, and group_name.
SSI_WEB_COLLECTIONS. Tied to ssi_web_collection_names and ssi_web_users tables. Collection names in the two tables must match and may be a drop down on this screen by populating from ssi_collection_names.
SSI_WEB_COLLECTION_DETAILS. Tied to ssi_collection_names, ssi_instances. Drop down for instance_id (actually display instance_name), and collection_name. Collection_id is auto-populated and displayed greyed out. Continue to have the functionality to “model” an instance based on existing instance. In other words, keep the functionality on instance editor, but add more features where each individual table can be edited. Each table (screen) should be controllable by userid as defined in the ssi_web_access reports and ssi_web_users table. Also, where applicable, each table (screen) should be controllable by instance_id and user id as defined by ssi_web_access_instances table.

The reporting engine 306 delivers all fixed and ad hoc reports to the users 314. The reports range from current and historical performance statistics, alert history, and outage and service level history. This reporting is dynamic in that no reports need to be developed manually. The reporting tool accesses the performance data stored in the repository 102. The web-based reporting features of the present invention include many features such as the console which displays all customer devices being managed and the status of those devices (green, yellow, and red). Yellow shows a warning alert condition and Red a critical alert condition. The web-based reporting tool also provides access to the historical statistics of all devices being managed, administration screens, and historical and current events. The web-based reporting tool is set up based on the rules to provide comprehensive views to operators and specific views based on roles to the customers.

The alert rules engine 302 evaluates data against alerting thresholds 316 and delivers warning alerts, critical alerts and escalation alerts 318. The alert rules engine 302 accesses either a customer's on-call data or contact data stored in the metadata dictionary in order to deliver the alerts and escalation to the appropriate individuals. The alert rules engine 302 is capable of providing the following features:

1. Page Multiple People On An Alert

2. Calendar Issues

3. On-call Calendar To Determine Whom To Page

4. Define Calendar Of When Paging Is Turned Off (i.e., Maintenance)

5. Paging Hours

6. Frequency To Determine When An Alert Has Occurred Enough

7. Sampling Frequency

8. Log History Of All Pages

9. Log History Of All Alert Conditions

10. Turn Off Paging After A Defined Frequency

11. Escalation Policy

12. Alert Conditions
i. CPU
ii. Swap
iii. Disk full
iv. Memory
v. Node up/down
vi. Messages file
vii. Database up/down
viii. Listener up/down
ix. Tablespace full
x. Max extents
xi. Alert log errors
xii. Locking
xiii. Deadlocks
xiv. Next Extent Size
xv. Backup logs/failure

The following table structures provide ways to gather data, process the data to see if it meets the rules defined for alerts using deamons, and send pages in case of an event using another deamon that reads the ssi_alerts table.

ssi_alert_pagers

Instance_id, server_id, primary_oncall_pager, secondary_oncall_pager, Primary pager_pin, secondary_pager_pin

This table will store information about the Oracle database ID that is tied back to ssi_instances, server ID that is tied back to the ssi_servers table, primary and secondary oncall pager e-mail or phone number, primary and secondary pager pin if one exists.

ssi_alert_pager_schedules

Instance_id, server_id, oncall_start_date, oncall_end_date, paging_hour_start, paging_hour_end

This table will store the on-call start and end dates for the oracle database or the server. This table also stores the pager hours if selective paging period is defined in a day. This table may have multiple entries for the same instance or server to store the different pager information based on the on-call schedule.

ssi_alert_escalations

Instance_id_server_id, alert_id, escalation_pager, escalation pager_pin, escalation_interval

This table will have the escalation pager, escalation pin if any, and escalation interval if any. Based on this information, a page will be sent to the escalation pager if a problem is not fixed in the defined period as stored in the escalation interval. This is based on alert ID, so that there is flexibility for selective escalation.

ssi_alert_definitions

Alert_id, alert_condition_name, alert_message

This is the table that defines the alerts. It is the source for alert_id and defines the name of the alert condition such as CPU, memory, disk full, etc. It will also store a message that will be sent out with the page.

ssi_alert_rules

Alert id, instance_id, server_id, alert_threshold, sampling_frequency, number_of_alerts, alert_tracking_period, number_of_event_occurrences

This table stores the rules for sending a page. These rules can vary by server or oracle database. Alert threshold defines the value of the alert_condition such as how full disk needs to get, etc. This will also hold the sampling frequency for each alert for each instance or server. The number of alerts during a given alert_tracking_period such as within 12 hours in a day will also be stored here. This information is used for escalation policy. This table will also define the rule for number of event occurrences before an alert results in a page.

ssi_alerts

Alert_id, Instance_id, server_id, alert_message, run_time

This table will get populated if a page needs to be sent. All the information is derived from other alert tables except the run_time which will be the time page was sent. This table will be empty most of the time as the entries are moved immediately to history table after successful paging.

ssi_alert_history

Alert_id, instance_id, server_id, alert_message, page_success, date_time_paged

This table stores the information from ssi_alerts after the page is sent.

ssi_cpu_alerts

Instance_id, server_id, alert_id, percent_idle, percent_busy, queue_length, run_time

This table stores the parameters outlined for CPU every time the server is sampled. The deamons will constantly check this table to see if an event occurs based on the rules defined in the rules table and if it does, then a row is inserted into ssi_alerts, which in turn is read by the paging deamon to send the page.

ssi_swap_alerts

Instance_id, server_id, alert_id, swap_used, page_ins, page_outs, run_time

This table stores the parameters outlined for swap and paging every time the server is sampled. The deamons will constantly check this table to see if an event occurs based on the rules defined in the rules table and if it does, then a row is inserted into ssi_alerts, which in turn is read by the paging deamon to send the page.

ssi_disk_alerts

Instance_id, server_id, alert_id, disk_used, disk_free, percent_disk_used, percent_disk_free, run_time

This table stores the parameters outlined for disk every time the server is sampled. The deamons will constantly check this table to see if an event occurs based on the rules defined in the rules table and if it does, then a row is inserted into ssi_alerts, which in turn is read by the paging deamon to send the page.

ssi_memory_alerts

Instance_id, server_id, alert_id, memory_used, memory_free, percent_memory_free, percent_memory_used, run_time

This table stores the parameters outlined for memory every time the server is sampled. The deamons will constantly check this table to see if an event occurs based on the rules defined in the rules table and if it does, then a row is inserted into ssi_alerts, which in turn is read by the paging deamon to send the page.

ssi_node_alerts

Instance_id, server_id, alert_id, node_message, run_time

This table stores whether a node is up or down every time the server is sampled. The deamons will constantly check this table to see if an event occurs based on the rules defined in the rules table and if it does, then a row is inserted into ssi_alerts, which in turn is read by the paging deamon to send the page.

ssi_os_messages_alerts

Instance_id, sever_id, alert_id, os_message, run_time

This table stores the alert messages from the OS messages file (if any) every time the server is sampled. The deamons will constantly check this table to see if an event occurs based on the rules defined in the rules table and if it does, then a row is inserted into ssi_alerts, which in turn is read by the paging deamon to send the page.

ssi_instance_alerts

Instance_id, server_id, alert_id, database_message, listener_message, run_time

This table stores whether the database and sq1*net are up or down every time the database is sampled. The deamons will constantly check this table to see if an event occurs based on the rules defined in the rules table and if it does, then a row is inserted into ssi_alerts, which in turn is read by the paging deamon to send the page.

ssi_tablespace_alerts

Instance_id, server_id, alert_id, tablespace_used, tablespace_free, percent_tablespace_used, percent_tablespace_free, run_time

This table stores the parameters outlined for tablespace every time the database is sampled. The deamons will constantly check this table to see if an event occurs based on the rules defined in the rules table and if it does, then a row is inserted into ssi_alerts, which in turn is read by the paging deamon to send the page.

ssi_maxextents_alerts

Instance_id, server_id, alert_id, extents, run_time

This table stores the parameters outlined for maxextents every time the database is sampled. The deamons will constantly check this table to see if an event occurs based on the rules defined in the rules table and if it does, then a row is inserted into ssi_alerts, which in turn is read by the paging deamon to send the page.

ssi_alertlog_alerts

Instance_id, server_id, alert_id, alert_message, run_time

This table stores the alert log messages (if any) every time the database is sampled. The deamons will constantly check this table to see if an event occurs based on the rules defined in the rules table and if it does, then a row is inserted into ssi_alerts, which in turn is read by the paging deamon to send the page.

ssi_lock_alerts

Instance_id, server_id, alert_id, lock_id, blocking_userid, blocked_object, type_of_lock, run_time

This table stores the parameters outlined for locks every time the database is sampled. The deamons will constantly check this table to see if an event occurs based on the rules defined in the rules table and if it does, then a row is inserted into ssi_alerts, which in turn is read by the paging deamon to send the page.

ssi_deadlock_alerts

Instance_id, server_id, alert_id, blocking_userid1, blocked_userid2, blocked_object1, blocked_object2, run_time

This table stores the parameters outlined for deadlocks every time the database is sampled. The deamons will constantly check this table to see if an event occurs based on the rules defined in the rules table and if it does, then a row is inserted into ssi_alerts, which in turn is read by the paging deamon to send the page.

ssi_extent_alerts

Instance_id, server_id, alert_id, next_extent_size, tablespace_freespace, run_time

This table stores the name of the tables every time the database is sampled to determine if the next extent will fit. The deamons will constantly check this table to see if an event occurs based on the rules defined in the rules table and if it does, then a row is inserted into ssi_alerts, which in turn is read by the paging deamon to send the page.

The server 300 is installed in or interfaced with the customer environment. After the server 300 is installed, then the devices (technology elements 108) to be managed are “plugged in” utilizing the SoftPlug features defined in the metadata stored in the repository 102. As a result, the server 300 can manage virtually any network connected device. Moreover, customized monitoring is available for these and additional devices including homegrown applications. Input application program interfaces (APIs) enable information to be input into the server 300 from other products or in-house developed customer applications. Output APIs enable the server 300 to integrate and send data to other products.

The applications profiler is a custom tailored performance manager that is developed to track application response time. Specific application transactions are run from a desktop where the time of the transaction is captured as well as the time when the transaction is complete. Alerts are generated based on preset thresholds being exceeded. The applications profiler enables a customer to monitor the applications performance as experienced by the end user and can be run from multiple locations.

Business process automation is achieved by working with each customer to define the business process requirements. The business processes are defined as data flows or system processes. For example, data feeds such as store sales from remote locations have a schedule when they should be available to the central application that is accumulating all sales for the day. The requirements are defined and the server 300 uses these requirements to perform the data feed and to alert if for any reason all of the data is not available. This can be happening in the middle of the night and if the present invention is not used, the business often doesn't recognize the problem until the next business day creating costly business delays.

Thresholds are established for both warning and critical alerts. These are defined based on the characteristics of the specific device. When an alert condition is detected (i.e. a problem), then an alert is generated. The alert engine then determines the action (warning alert/critical alert) and then alerts the individual or individuals defined to be alerted for the specific device. This alert can be sent to the server support team or the customer or both depending on the services agreement defined with that specific customer. The server 300 tracks the alert condition, sends additional alerts based on the rules, and then escalates the alert with up to four levels of escalation available. The number of pages sent on a problem condition is predefined in the custom set-up. For example, three pages can be sent and then paging to those individuals turned off. Scheduled maintenance windows can be set up at any time in the administration sub-system to prevent paging. These can be set up on a scheduled basis or can be set up to turn paging off when a server or device is going to be brought down for maintenance. Changes to alert and paging rules can be made at anytime. This includes changing alert thresholds as well as the individuals or groups to be alerted. These can be done by a phone request to the server support team who will make the changes or by the server administrator through the administration subsystem.

Server 300 via reporting engine 306 provides a wide array of periodic reporting including daily, weekly, and monthly reports. These reports provide details on outages, alerts generated, and performance trends on the critical performance metrics based on the device type. These reports are available in PDF and text formats and are e-mailed to the designated personnel based on the report and the device type. Server 300 includes its own ad hoc reporting engine enabling access to all current and historical performance and service level information stored in the repository 102.

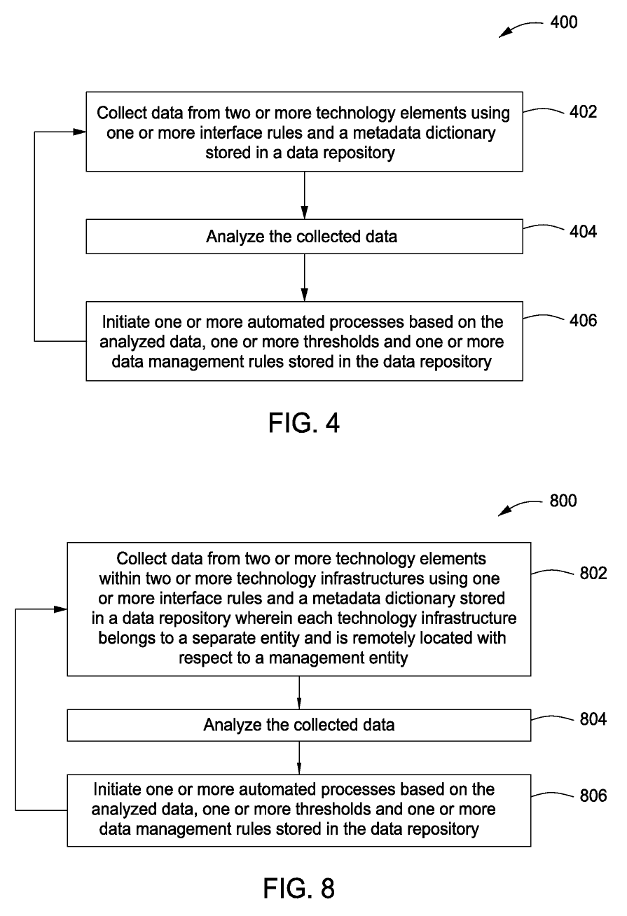

Referring now to FIG. 4, a flow chart of a method 400 for managing a technology infrastructure having two or more technology elements in accordance with a fourth embodiment of the present invention is shown. Data is collected from the technology elements using one or more interface rules and a metadata dictionary stored in a data repository in block 402. The collected data is analyzed in block 404. One or more automated processes are initiated in block 406 based on the analyzed data, one or more thresholds and one or more management rules stored in the data repository. The process loops back to collect data in block 402 and the method is repeated to continuously monitor, analyze and dynamically manage the monitored technology infrastructure. Note that this method can be implemented using a computer program embodied on a computer readable medium wherein the steps are preformed by one or more code segments.

The method 400 can also include the following functions:

display a graphical representation showing a status of the technology elements wherein the status of each technology element is indicated by a color code;

access the data repository, analyzed data, the thresholds, the management rules, the interface rules or a combination thereof via a web-based browser;

limit access to the data repository, analyzed data, the thresholds, the management rules, the interface rules or a combination thereof based on a user security profile;

set up user security profiles, manage passwords, manage the thresholds, determine sampling frequencies, manage change requests or a combination thereof;

provide one or more periodic reports wherein the periodic reports provide details about outages, alerts generated, current performance statistics, historical performance statistics, alert history, service level history, performance trends of the technology elements or a combination thereof;

automatically send the periodic reports to one or more users wherein the user is determined by one or more technology elements listed in the periodic reports;

define one or more business process requirements comprising one or more data flows, system processes or a combination thereof;

issue an alert whenever the data is not collected;

track a response time for one or more of the technology elements;

export data to one or more applications;

store the collected data or retrieve and provide historical data;

dynamically configure the technology elements based on the interface rules, the metadata dictionary, the management rules or a combination thereof;

automatically discover and configure the technology infrastructure;

automatically set up a customer specific alert generator; and/or

automatically set up a technology specific alert generator.

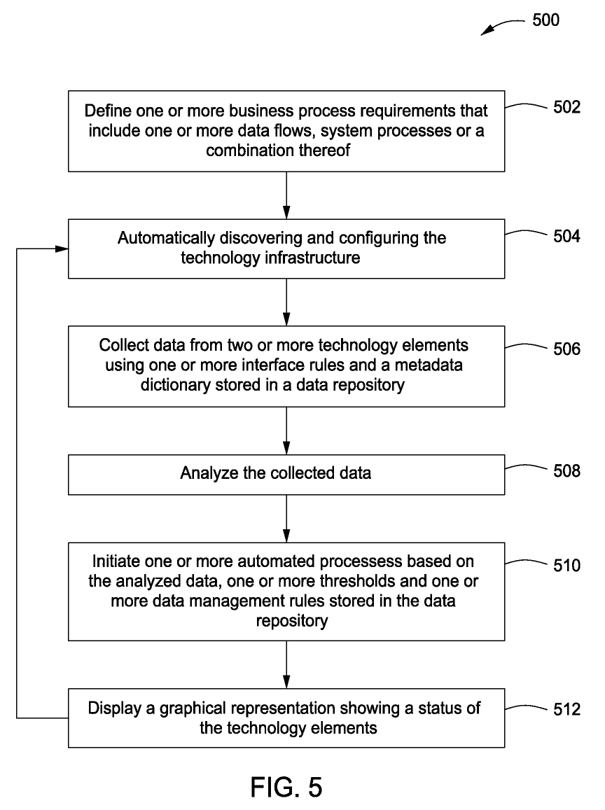

Now referring to FIG. 5, a flow chart of a method 500 for managing a technology infrastructure having two or more technology elements in accordance with a fifth embodiment of the present invention is shown. One or more business process requirements that include one or more data flows, system processes or a combination thereof are defined in block 502. The technology infrastructure is automatically discovered and configured in block 504. Data is collected from the technology elements using one or more interface rules and a metadata dictionary stored in a data repository in block 506. The collected data is analyzed in block 508. One or more automated processes are initiated in block 510 based on the analyzed data, one or more thresholds and one or more management rules stored in the data repository. A graphical representation showing the status of the technology elements is displayed in block 512. The process loops back to discover and configure changes in the technology infrastructure in block 504 and the method is repeated to continuously monitor, analyze and dynamically manage the monitored technology infrastructure. Note that this method can be implemented using a computer program embodied on a computer readable medium wherein the steps are preformed by one or more code segments.

The method 500 can also include the following functions:

access the data repository, analyzed data, the thresholds, the management rules, the interface rules or a combination thereof via a web-based browser;

limit access to the data repository, analyzed data, the thresholds, the management rules, the interface rules or a combination thereof based on a user security profile;

set up user security profiles, manage passwords, manage the thresholds, determine sampling frequencies, manage change requests or a combination thereof;

provide one or more periodic reports wherein the periodic reports provide details about outages, alerts generated, current performance statistics, historical performance statistics, alert history, service level history, performance trends of the technology elements or a combination thereof;

automatically send the periodic reports to one or more users wherein the user is determined by one or more technology elements listed in the periodic reports;

automatically set up a customer specific alert generator;

automatically set up a technology specific alert generator;

issue an alert whenever the data is not collected, track a response time for one or more of the technology elements, export data to one or more applications, store the collected data or retrieve and provide historical data; and/or

dynamically configure the technology elements based on the interface rules, the metadata dictionary, the management rules or a combination thereof.

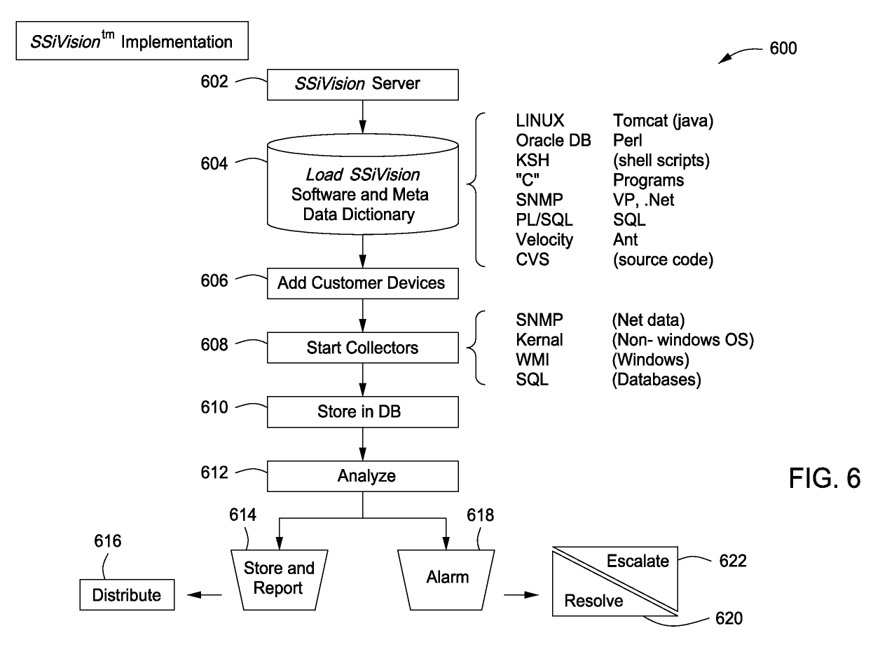

Referring now to FIG. 6, a flow chart of a method 600 for managing a technology infrastructure in accordance with a sixth embodiment of the present invention is shown. The server or apparatus (FIGS. 1-3) is installed in block 602. The software implementing the present invention and the metadata dictionary are loaded in block 604. The customer devices are added in block 606 and the collectors are started in block 608. Data from the customer devices (technology elements) is collected by the collectors and stored in the database (repository) in block 610. The data is analyzed in block 612 and the results are stored and/or reported in block 614 and distributed as necessary in block 616. The analysis can trigger alarms 618 that are resolved 620 or escalated 622.

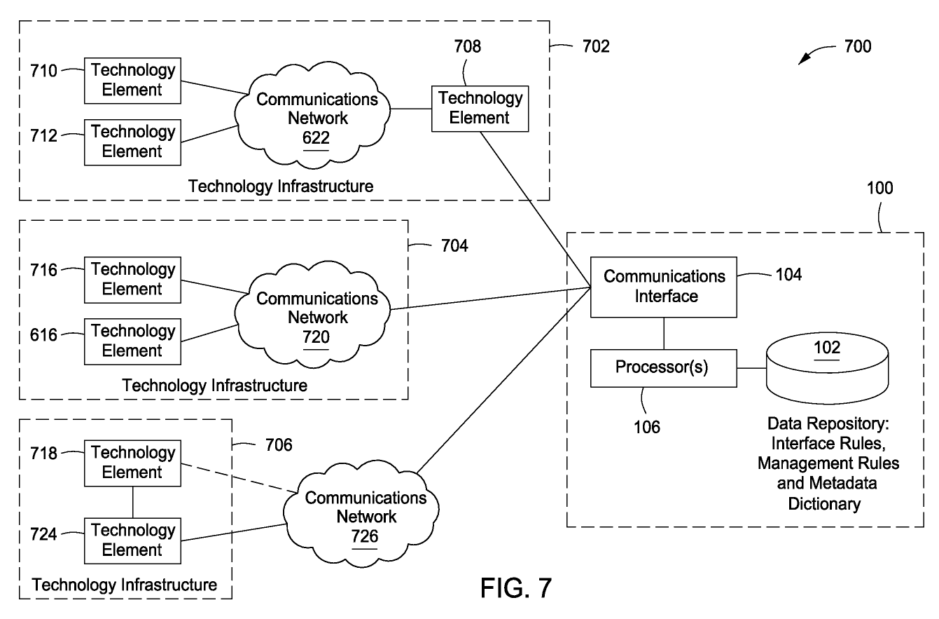

Now referring to FIG. 7, a block diagram of a system 700 for managing a technology infrastructure in accordance with a seventh embodiment of the present invention is shown. The system 700 manages all major technologies for a virtually unlimited number of customers using the apparatus or server 100. It doesn't matter where the customer is located, the processes and technology of the present invention allow the environments to be monitored remotely. As a result, the present invention can enable businesses to reduce the cost of managing the technology environment by over 40% versus hiring internal expertise or consultants. Multiple support centers 100 can be used to maintain a very efficient cost structure. Geographically distributed support centers 100 allow for optimum 24×7 “follow the sun” staff scheduling.

System 700 includes a server 100 communicably coupled to two or more technology infrastructures 702, 704 and 706. The server 100 (see also FIGS. 1-3) includes a data repository 102, a communications interface 104 and one or more processors 106 communicably coupled to the data repository 102 and the communications interface 104. The data repository 102 has one or more rules for managing and interfacing with two or more technology elements within the technology infrastructures 702, 704 and 706, and a metadata dictionary. The one or more processors 106 are configured to collect data from the technology elements within the technology infrastructures 702, 704 and 706 via the communications interface 104 using the interface rules and the metadata dictionary, analyze the collected data, and initiate one or more automated processes based on the analyzed data, one or more thresholds and the management rules.

The technology infrastructures 702, 704 and 706 can take any form or configuration of network connected devices in use now or in the future. For example, technology infrastructure 702 includes a technology element 708, such as a firewall/router, communicably coupled to technology elements 710 and 712 via a local or private communications network 714. Technology element 708 is connected (as shown) or communicably coupled via a network to the communications interface 104. Technology infrastructure 704 includes technology elements 716 and 718 communicably coupled to a communications network 720, which is in turn communicably coupled to the communications interface 104. Technology infrastructure 706 includes technology elements 722 and 724 that are communicably coupled together. Technology element 724 is communicably coupled to an outside communications network 726, which is in turn communicably coupled to the communications interface 104. Technology element 722 may or may not be communicably coupled to communications network 726.

System 700 can be used to outsource management of one or more of the technology infrastructures 702, 704 and 706. In such a case, each technology infrastructure will typically belong to a separate entity and is remotely located with respect to a management entity that includes server 100. The management entity via server 100 can manage the technology infrastructure at a price that is less than the cost for the separate entity to manage the technology infrastructure. Moreover, the management entity via server 100 can manage a portion of the technology infrastructure, such as technology element 710. The managed portion of the technology infrastructure 702, 704 and 706 may include one or more legacy technology elements, one or more splintered technology elements, one or more specialized technology elements, one or more small-scale technology elements or a combination thereof.

Referring now to FIG. 8, a flow chart of a method 800 for outsourcing management of one or more technology infrastructures in accordance with an eighth embodiment of the present invention is shown. Data is collected from two or more technology elements within two or more technology infrastructures using one or more interface rules and a metadata dictionary stored in a data repository in block 802. Each technology infrastructure belongs to a separate entity and is remotely located with respect to a management entity. The collected data is analyzed in block 804. One or more automated processes are initiated in block 806 based on the analyzed data, one or more thresholds and one or more management rules stored in the data repository. The process loops back to collect data in block 802 and the method is repeated to continuously monitor, analyze and dynamically manage the monitored technology infrastructure. Note that this method can be implemented using a computer program embodied on a computer readable medium wherein the steps are preformed by one or more code segments.

The method 800 can also include the following functions:

display a graphical representation showing a status of the technology elements wherein the status of each technology element is indicated by a color code;

access the data repository, analyzed data, the thresholds, the management rules, the interface rules or a combination thereof via a web-based browser;

limit access to the data repository, analyzed data, the thresholds, the management rules, the interface rules or a combination thereof based on a user security profile;

set up user security profiles, manage passwords, manage the thresholds, determine sampling frequencies, manage change requests or a combination thereof;

provide one or more periodic reports wherein the periodic reports provide details about outages, alerts generated, current performance statistics, historical performance statistics, alert history, service level history, performance trends of the technology elements or a combination thereof;

automatically send the periodic reports to one or more users wherein the user is determined by one or more technology elements listed in the periodic reports;

define one or more business process requirements comprising one or more data flows, system processes or a combination thereof;

issue an alert whenever the data is not collected;

track a response time for one or more of the technology elements;

export data to one or more applications;

store the collected data or retrieve and provide historical data;

dynamically configure the technology elements based on the interface rules, the metadata dictionary, the management rules or a combination thereof;

automatically discover and configure the technology infrastructure;

automatically set up a customer specific alert generator; and/or

automatically set up a technology specific alert generator.

The management entity can manage the technology infrastructure at a price that is less than the cost for the separate entity to manage the technology infrastructure. For example, the price can be less than or equal to 70% of the cost. Moreover, the management entity can manage a portion of the technology infrastructure. The managed portion of the technology infrastructure may include one or more legacy technology elements, one or more splintered technology elements, one or more specialized technology elements, one or more small-scale technology elements or a combination thereof.

The present invention delivers the functionality to reduce the cost and complexity of managing technology. For example, in one pricing structure, a low monthly charge is based solely on the number of devices being managed with the system. The following brief checklist illustrates some of the different ways that the present invention represents a significantly lower total cost of ownership than alternative solution options.

Software Cost: The cost of licensing the software can be substantial, especially when managing multiple technical platforms. There is no software purchase cost with the present invention.

Software Maintenance Cost: A software purchase is accompanied by a maintenance contract that will enable businesses to apply patches and upgrade as the product changes. This is normally an annual charge of 15% to 25% of the software cost and applies to multiple tools to manage the total environment. There is no maintenance cost with the present invention.

Training Cost: New products require training of the staff to learn how to implement, maintain, and support the product. It is generally necessary to train multiple persons to ensure coverage and have backup to the primary technicians. Include time away from the office dedicated for training, training class costs, and travel costs (if applicable). Also, include the costs for on-going training to stay abreast of the technology. There is no training cost with the present invention.

Consulting Cost: Most products are complex and it is often necessary to hire experts either from the company where the product is purchased or other consulting firms to develop an implementation plan or to manage the product implementation. The total cost of consulting should also include the cost of your staff working with the consultants. There is no consulting cost associated with the present invention.

Implementation Cost: The resource costs (internal or external) necessary to configure the environment (hardware to run on, security, etc.), implement the software, document the processes, bring on board all users, and effectively get the system to full functionality. There is no implementation cost with the present invention.

Integration Cost: There are generally many integration factors involved with implementing the capabilities that a new software product enables. Integrating with other software programs and current processes can be a very time consuming and costly initiative. There are often many different individuals involved in the integration from different groups and all of their time needs to be included in the total cost. There is no integration cost with the present invention.

Support Cost: A team of individuals is required to support the software product. This is usually a minimum of two to ensure backup support is available. This is often many more hours and much more extensive than planned. The work these individuals are involved in includes troubleshooting problems, working with system users, communicating with the vendor, dealing with hardware or environment problems, changing the technologies to be managed, and the on-going changes to make the product work to meet specific business requirements. There is no team necessary to support the present invention.

Maintenance Staff Cost: System maintenance includes applying software patches, upgrading the product, and testing new releases prior to production. Also, time must be spent keeping up with the product news and knowing when maintenance needs to be applied. Also, include time spent with system users communicating and coordinating maintenance. There is no maintenance cost with the present invention.

Technology Transformation Cost: Technology is always changing. Hardware is being upgraded, software is being upgraded, new technologies are being implemented, and systems management software must change to manage the new technologies. Cost should be included based on the work that it takes for a team to keep up with the ever-changing environments. With the present invention, there is no cost for transformation. Upgrades to new releases are handled by the management entity, and there is no charge for changing technologies.

Costs for tailoring for a customer environment: No software fits every business's needs out of the box. Most meet less than 75% of the business requirements. Include the costs for the design and development work necessary to tailor the solution to fit the business requirements. Also, include the work to complete the business intelligence summary reports necessary for management to see what is happening with the technology as well as communicating with the business. This is often an additional resource requirement. The present invention is designed for easy tailoring and usually can be done for no additional cost.

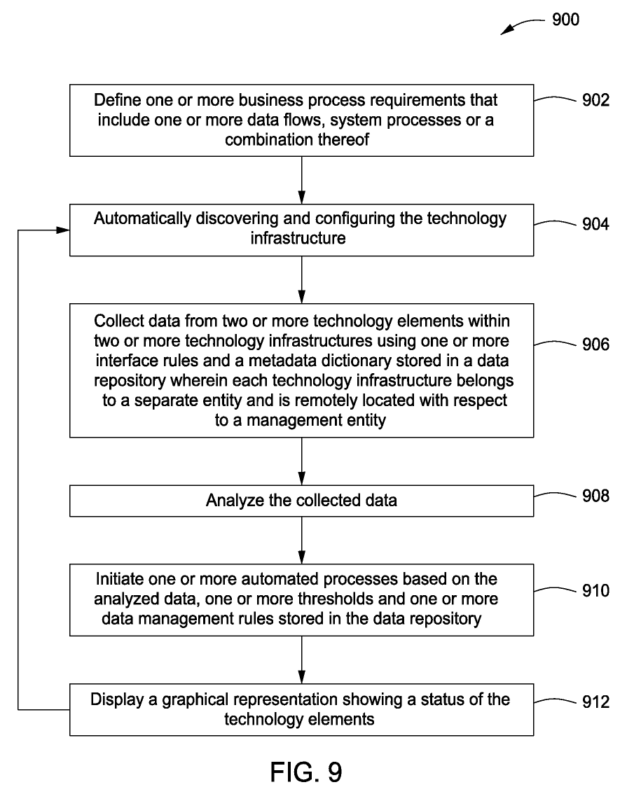

Now referring to FIG. 9, a flow chart of a method 900 for outsourcing management of one or more technology infrastructures in accordance with a ninth embodiment of the present invention is shown. One or more business process requirements that include one or more data flows, system processes or a combination thereof are defined in block 902. The technology infrastructure(s) is automatically discovered and configured in block 904. Data is collected from the technology elements within the technology infrastructure(s) using one or more interface rules and a metadata dictionary stored in a data repository in block 906. Each technology infrastructure belongs to a separate entity and is remotely located with respect to a management entity. The collected data is analyzed in block 908. One or more automated processes are initiated in block 910 based on the analyzed data, one or more thresholds and one or more management rules stored in the data repository. A graphical representation showing the status of the technology elements is displayed in block 912. The process loops back to discover and configure changes in the technology infrastructure(s) in block 904 and the method is repeated to continuously monitor, analyze and dynamically manage the monitored technology infrastructure(s). Note that this method can be implemented using a computer program embodied on a computer readable medium wherein the steps are preformed by one or more code segments.

The method 900 can also include the following functions:

access the data repository, analyzed data, the thresholds, the management rules, the interface rules or a combination thereof via a web-based browser;

limit access to the data repository, analyzed data, the thresholds, the management rules, the interface rules or a combination thereof based on a user security profile;

set up user security profiles, manage passwords, manage the thresholds, determine sampling frequencies, manage change requests or a combination thereof;

provide one or more periodic reports wherein the periodic reports provide details about outages, alerts generated, current performance statistics, historical performance statistics, alert history, service level history, performance trends of the technology elements or a combination thereof;

automatically send the periodic reports to one or more users wherein the user is determined by one or more technology elements listed in the periodic reports;

automatically set up a customer specific alert generator;

automatically set up a technology specific alert generator;

issue an alert whenever the data is not collected, track a response time for one or more of the technology elements, export data to one or more applications, store the collected data or retrieve and provide historical data; and/or

dynamically configure the technology elements based on the interface rules, the metadata dictionary, the management rules or a combination thereof.

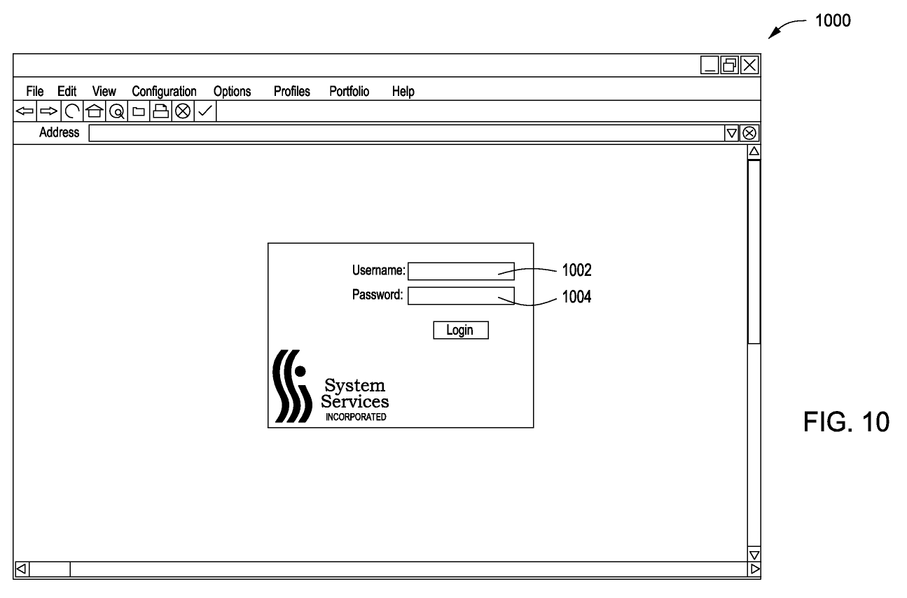

Referring now to FIG. 10, a screen shot of a login screen 1000 of a computer program for managing a technology infrastructure in accordance with a tenth embodiment of the present invention is shown. The computer program of the present invention can be accessed through a customer specific web-site. Each user of the system is assigned different levels of access determined by their role and area of responsibility. The administrator will set up user names and IDs, assign default passwords, manage alerting thresholds, determine sampling frequencies, and manage change requests. The designated user name 1002 and password 1004 (both case sensitive) must be entered to login to system. Each user will have the ability to change passwords once in the system. Once into the system, access is determined based on the profile of the user ID. The default entry screen is the enterprise scoreboard screen (FIG. 1100) providing a graphical view of all devices the user has access.

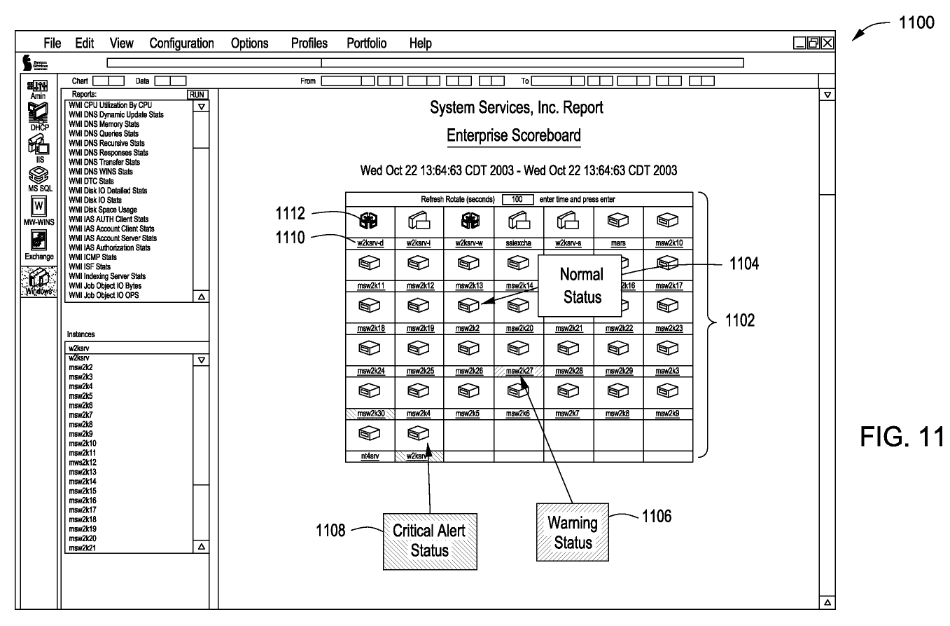

Now referring to FIG. 11, a screen shot of an enterprise scoreboard screen 1100 of a computer program for managing a technology infrastructure in accordance with the tenth embodiment of the present invention is shown. The enterprise scoreboard 1100 is the console displaying the current status of all devices 1102 (e.g., servers, databases, applications, network devices, critical processes, etc.) the user ID has access. Access to all web-based reporting for all devices 1102 including metrics and system administration is available from the enterprise scoreboard 1100. The color coding on the scoreboard 1100 determines if any current alerts have been generated for the specific devices 1102:

| | |
|---|---|
| GREEN 1104: | No thresholds currently exceeded. Normal status. |
| YELLOW 1106: | A warning threshold has been exceeded and alert |
| | generated. Warning status. |
| RED 1108: | A critical threshold has been exceeded and alert |
| | generated. Critical alert status. |

In other words, the condition of each device is compared to the preset thresholds and the color of the icon is changed accordingly. The name of the device 1110 (server name, db name, etc.) will be displayed under the device graphic 1112. Individual graphics 1112 will designate servers, databases, applications, and processes that are being monitored. Customized views enable access based on specific roles and areas of responsibility.

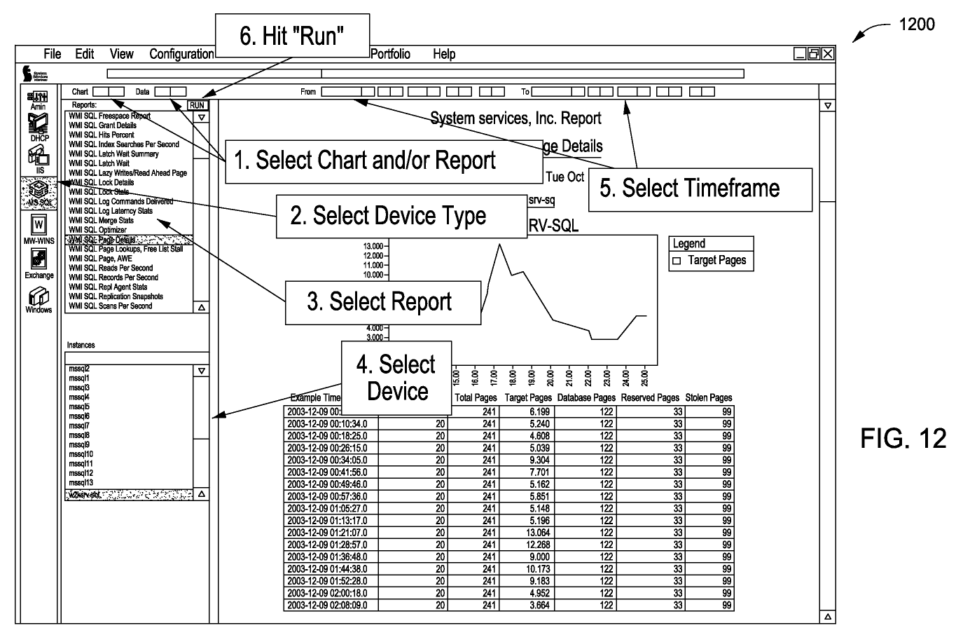

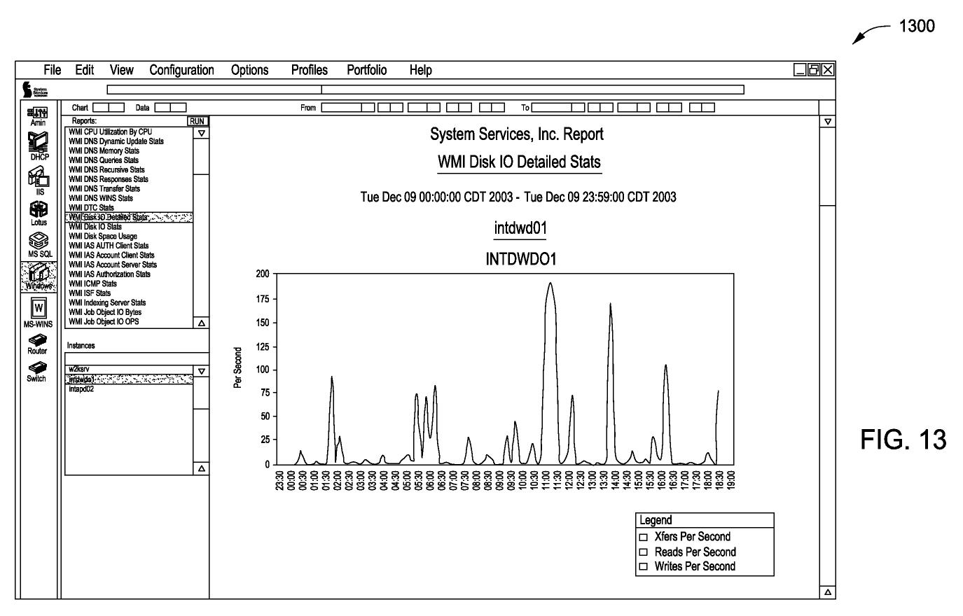

Referring now to FIG. 12, a screen shot of a first report screen 1200 of a computer program for managing a technology infrastructure in accordance with the tenth embodiment of the present invention is shown. Access to performance metrics reporting is available by performing the following steps:

| | |
|---|---|
| STEP 1: | Select Chart, Report, or both. |
| STEP 2: | Select the device type to report on. Note that when the device |
| | type is designated, a second drop down menu will display all |
| | metrics available for that device type. |
| STEP 3: | Select the metrics to report on. |
| STEP 4: | Select the specific devices to report on. Note that the device can |
| | either be selected via the drop down menu or by typing in the |
| | device name in the designated window “Instances”. |
| STEP 5: | Select the date range for the report. |
| STEP 6: | Hit “Run”. |

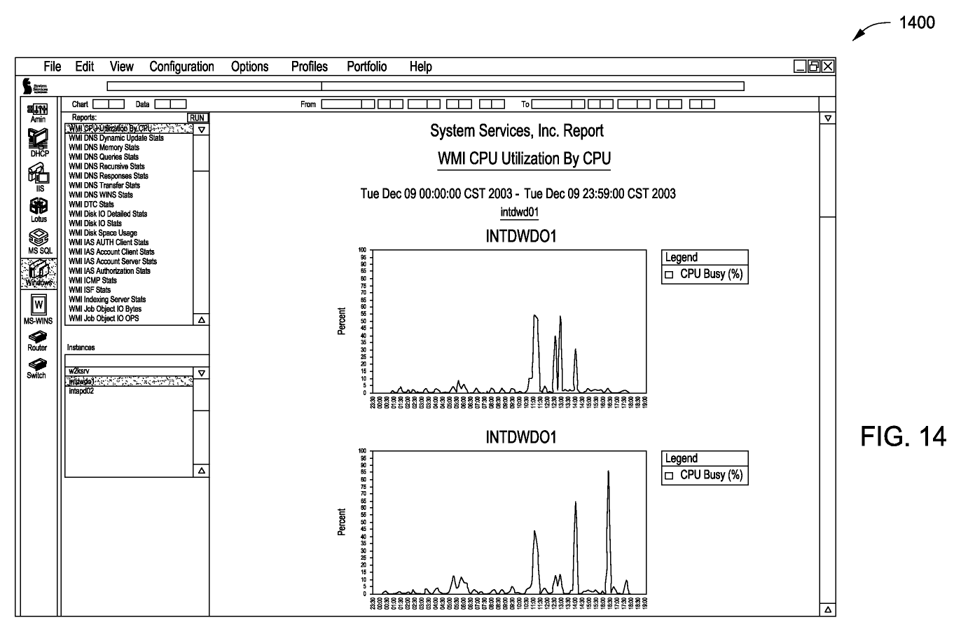

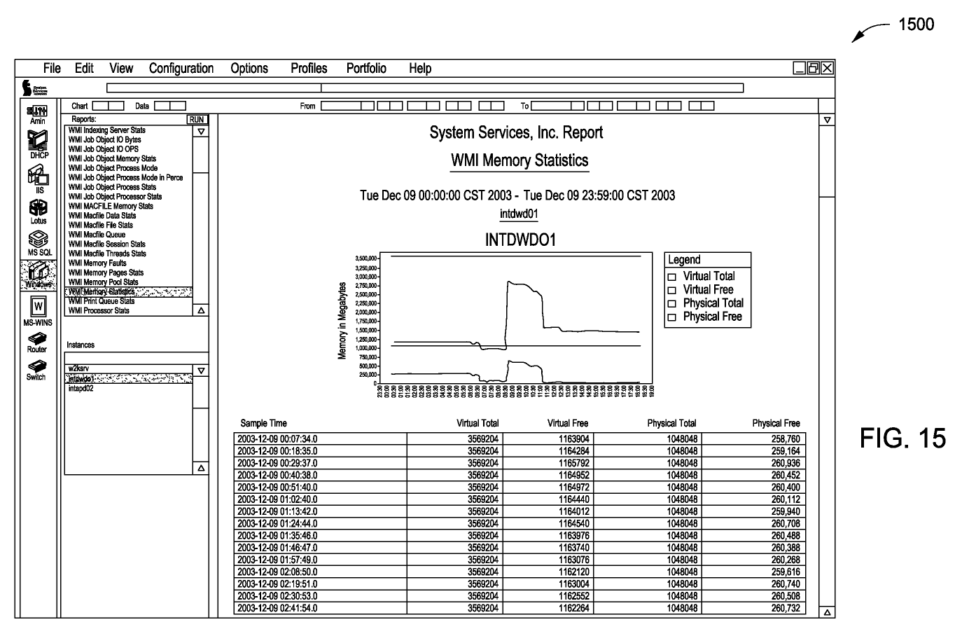

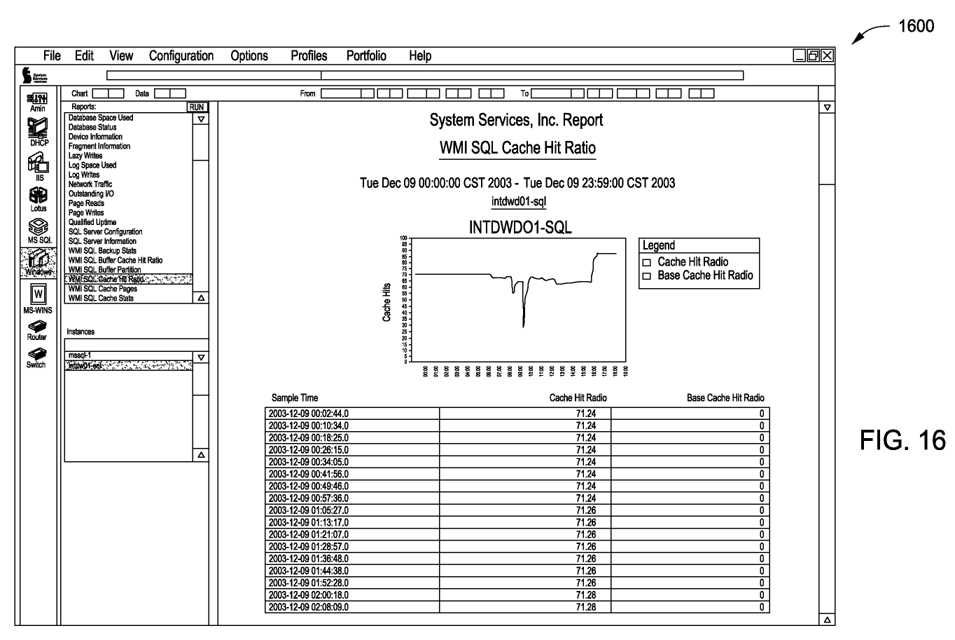

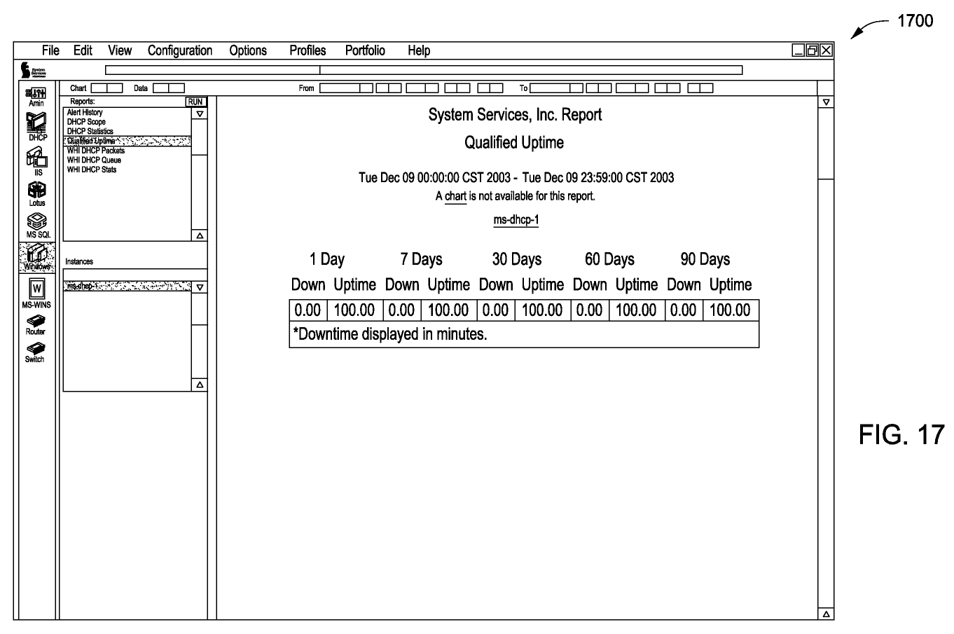

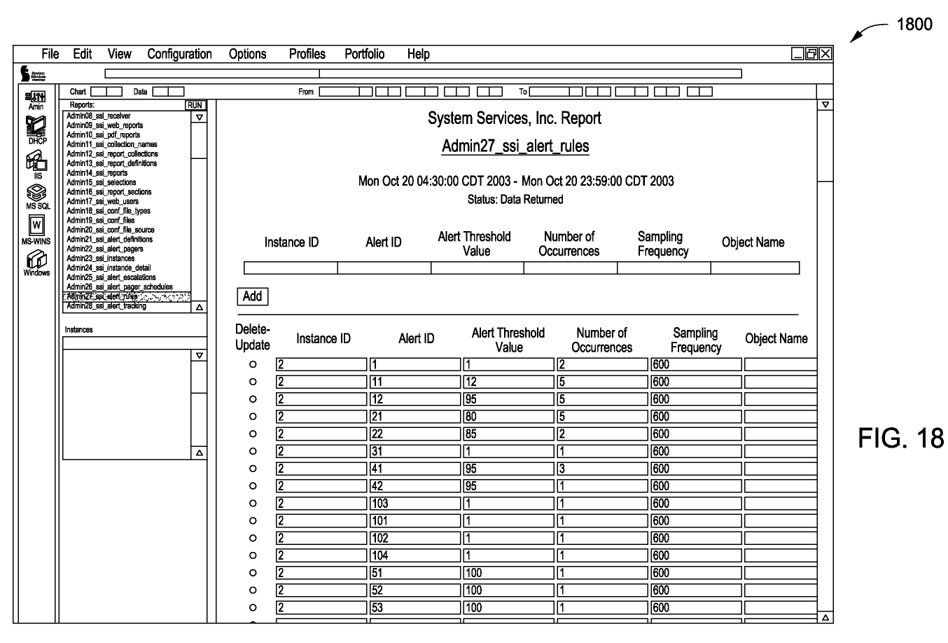

Note that this interface also provides access to the administration sub-system (icon) and service level reports. The present invention provides easy access to all current and historical performance metrics for all devices being managed. This in-depth information enables fact-based decision making and improves communications within the IT organization and with the business. Examples of other report screens are depicted in FIGS. 13-18.

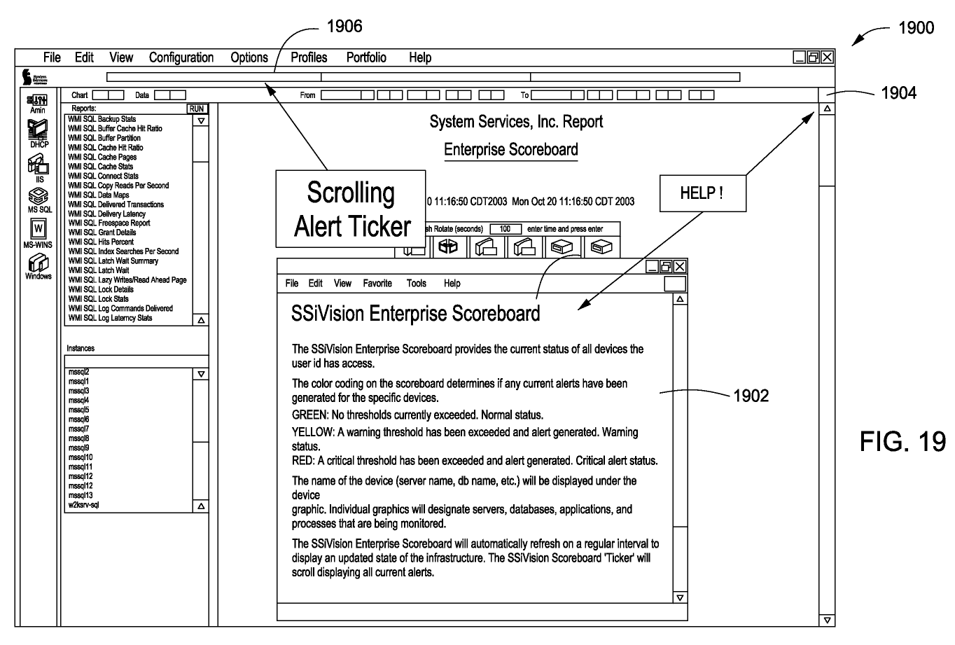

Now referring to FIG. 19, a screen shot of a eighth report screen 1900 of a computer program for managing a technology infrastructure in accordance with the tenth embodiment of the present invention is shown. Help 1902 via button 1904 is accessible from anywhere within the technology enabling access to tips to most effectively utilize the system with minimal training. In addition, an alert ticker 1906 scrolls across the screen showing all current alerts.

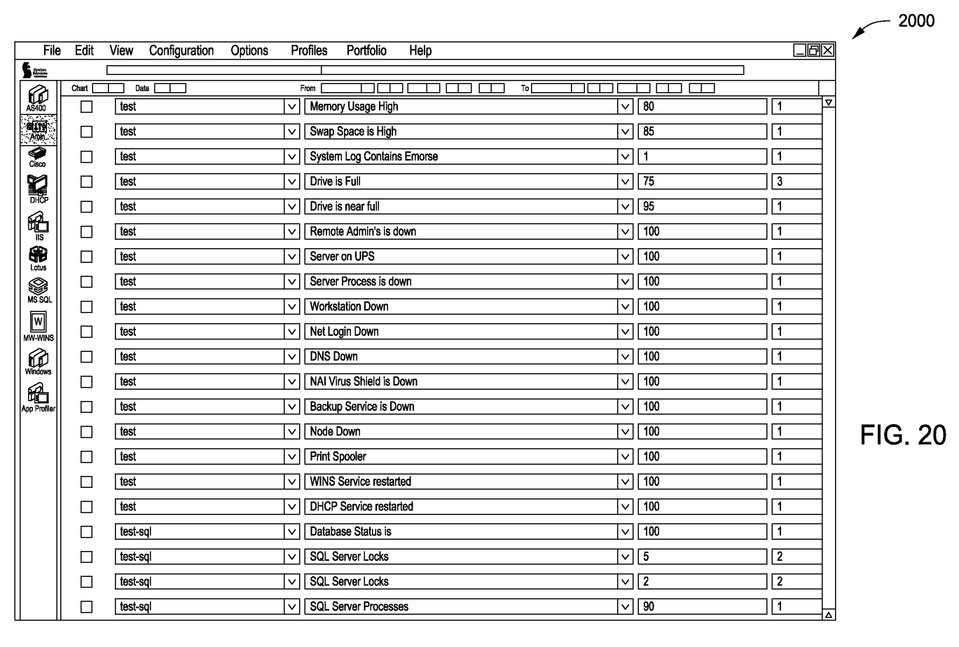

Referring now to FIG. 20, a screen shot of a ninth report screen 2000 of a computer program for managing a technology infrastructure in accordance with the tenth embodiment of the present invention is shown. Report screen 2000 allows the user to set up and/or modify alert rules. The system enables all devices to be proactively managed through easy to use administration screens. For example, level 1 thresholds being exceeded causes a warning alert to be generated. The device on the Scoreboard will change from green to yellow and the predefined alert process commences (e-mail or page sent to responsible individuals). Level 2 thresholds being exceeded cause a critical alert to be generated. The device on the Scoreboard changes to red and the predefined alert process commences. The system can also provide robust daily, weekly, and monthly reports delivered via e-mail. These reports show systems availability, alert history and critical performance trends. They reports are easily customized to focus on the specific areas of importance to the user/customer.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although preferred embodiments of the present invention have been described in detail, it will be understood by those skilled in the art that various modifications can be made therein without departing from the spirit and scope of the invention as set forth in the appended claims.

What is claimed is:

1. A method for outsourcing management of one or more technology infrastructures having two or more technology elements comprising the steps of:
collecting data from the technology elements using one or more interface rules and a metadata dictionary stored in a data repository wherein each technology infrastructure belongs to a separate entity and is remotely located with respect to a management entity;
analyzing the collected data; and
initiating one or more automated processes based on the analyzed data, one or more thresholds and one or more management rules stored in the data repository.

2. The method as recited in claim 1, wherein the technology elements comprise one or more computers, one or more laptops, one or more workstations, one or more processors, one or more servers, one or more communication devices, one or more network devices, one or more switches/routers, one or more security devices, one or more applications, one or more business processes, one or more utilities, one or more data backup/recovery processes or devices, one or more databases, one or more operating systems or a combination thereof.

3. The method as recited in claim 1, wherein the automated processes comprise correcting the technology elements, troubleshooting the technology elements, detecting and interfacing with one or more new technology elements, detecting one or more changes in the technology elements, correcting detected defects, correcting detected problems, reporting alerts, reporting warnings, reporting errors, reporting statistics, reporting a status of the technology elements, generating customer specific reports, maintaining the technology elements, updating the technology elements, providing one or more notifications, creating one or more audit trails, creating one or more security logs, monitoring security of the technology elements or a combination thereof.

4. The method as recited in claim 1, further comprising the step of displaying a graphical representation showing a status of the technology elements.

5. The method as recited in claim 4, wherein the status of each technology element is indicated by a color code.

6. The method as recited in claim 1, wherein the management entity manages the technology infrastructure at a price that is less than a cost for the separate entity to manage the technology infrastructure.

7. The method as recited in claim 6, wherein the price is less than or equal to 70% of the cost.

8. The method as recited in claim 6, wherein the price is 40% to 70% of the cost.

9. The method as recited in claim 1, wherein the management entity only manages a portion of the technology infrastructure.

10. The method as recited in claim 9, wherein the managed portion of the technology infrastructure comprises one or more legacy technology elements, one or more splintered technology elements, one or more specialized technology elements, one or more small-scale technology element or a combination thereof.

11. The method as recited in claim 1, wherein the method improves a reliability and a performance of the technology infrastructure, reduces the cost to the separate entity, reduces a number of employees required by the separate entity or a combination thereof.

12. The method as recited in claim 1, further comprising the step of accessing the data repository, analyzed data, the thresholds, the management rules, the interface rules or a combination thereof via a web-based browser.

13. The method as recited in claim 12, further comprising the step of limiting access to the data repository, analyzed data, the thresholds, the management rules, the interface rules or a combination thereof based on a user security profile.

14. The method as recited in claim 1, further comprising the step of setting up user security profiles, managing passwords, managing the thresholds, determining sampling frequencies, managing change requests or a combination thereof.

15. The method as recited in claim 1, further comprising the step of providing one or more periodic reports.

16. The method as recited in claim 15, wherein the periodic reports provide details about outages, alerts generated, current performance statistics, historical performance statistics, alert history, service level history, performance trends of the technology elements or a combination thereof.

17. The method as recited in claim 15, further comprising the step of automatically sending the periodic reports to one or more users.

18. The method as recited in claim 17, wherein the user is determined by one or more technology elements listed in the periodic reports.

19. The method as recited in claim 1, wherein the thresholds are defined based on one or more characteristics of the technology elements.

20. The method as recited in claim 1, further comprising the step of defining one or more business process requirements comprising one or more data flows, system processes or a combination thereof.

21. The method as recited in claim 1, further comprising the steps of:
issuing an alert whenever the data is not collected;
tracking a response time for one or more of the technology elements;
exporting data to one or more applications;
storing the collected data; or
retrieving and providing historical data.

22. The method as recited in claim 1, further comprising the step of dynamically configuring the technology elements based on the interface rules, the metadata dictionary, the management rules or a combination thereof.

23. The method as recited in claim 1, wherein the data is collected using WMI whenever the technology element comprises a Microsoft Windows environment, SNMP whenever the technology element comprises a network device, SQL whenever the technology element comprises a database and native O/S commands whenever the technology element comprises a Unix or Linux environment.

24. The method as recited in claim 1, wherein the data repository further comprises key relationships between the technology elements for successfully completing a business process, customer mapping of the technology elements, functional relationships of the technology elements, key performance indicators, auto correction rules based on event logic, escalation rules or a combination thereof.

25. The method as recited in claim 1, wherein the data repository includes a unique device identification, a device name, a device type and a device data model for each technology element.

26. The method as recited in claim 1, further comprising the steps of:
automatically discovering and configuring the technology infrastructure;
automatically setting up a customer specific alert generator; or
automatically setting up a technology specific alert generator.

27. A computer program embodied on a computer readable medium for outsourcing management of one or more technology infrastructures having two or more technology elements comprising:
a code segment for collecting data from the technology elements using one or more interface rules and a metadata dictionary stored in a data repository wherein each technology infrastructure belongs to a separate entity and is remotely located with respect to a management entity;
a code segment for analyzing the collected data; and
a code segment for initiating one or more automated processes based on the analyzed data, one or more thresholds and one or more management rules stored in the data repository.

28. The computer program as recited in claim 27, wherein the technology elements comprise one or more computers, one or more laptops, one or more workstations, one or more processors, one or more servers, one or more communication devices, one or more network devices, one or more switches/routers, one or more security devices, one or more applications, one or more business processes, one or more utilities, one or more data backup/recovery processes or devices, one or more databases, one or more operating systems or a combination thereof.

29. The computer program as recited in claim 27, wherein the automated processes comprise correcting the technology elements, troubleshooting the technology elements, detecting and interfacing with one or more new technology elements, detecting one or more changes in the technology elements, correcting detected defects, correcting detected problems, reporting alerts, reporting warnings, reporting errors, reporting statistics, reporting a status of the technology elements, generating customer specific reports, maintaining the technology elements, updating the technology elements, providing one or more notifications, creating one or more audit trails, creating one or more security logs, monitoring security of the technology elements or a combination thereof.

30. The computer program as recited in claim 27, further comprising a code segment for displaying a graphical representation showing a status of the technology elements.

31. The computer program as recited in claim 27, wherein the management entity manages the technology infrastructure at a price that is less than a cost for the separate entity to manage the technology infrastructure.

32. The computer program as recited in claim 31, wherein the price is less than or equal to 70% of the cost.

33. The computer program as recited in claim 31, wherein the price is 40% to 70% of the cost.

34. The computer program as recited in claim 27, wherein the management entity only manages a portion of the technology infrastructure.

35. The computer program as recited in claim 34, wherein the managed portion of the technology infrastructure comprises one or more legacy technology elements, one or more splintered technology elements, one or more specialized technology elements, one or more small-scale technology element or a combination thereof.

36. The computer program as recited in claim 27, wherein the computer program improves a reliability and a performance of the technology infrastructure, reduces the cost to the separate entity, reduces a number of employees required by the separate entity or a combination thereof.

37. The computer program as recited in claim 27, further comprising a code segment for accessing the data repository, analyzed data, the thresholds, the management rules, the interface rules or a combination thereof via a web-based browser.

38. The computer program as recited in claim 27, wherein the thresholds are defined based on one or more characteristics of the technology elements.

39. The computer program as recited in claim 27, further comprising a code segment for defining one or more business process requirements comprising one or more data flows, system processes or a combination thereof.

40. The computer program as recited in claim 27, further comprising:
a code segment for issuing an alert whenever the data is not collected;
a code segment for tracking a response time for one or more of the technology elements;
a code segment for exporting data to one or more applications;
a code segment for storing the collected data; or
a code segment for retrieving and providing historical data.

41. The computer program as recited in claim 27, further comprising a code segment for dynamically configuring the technology elements based on the interface rules, the metadata dictionary, the management rules or a combination thereof.

42. The computer program as recited in claim 27, wherein the data is collected using WMI whenever the technology element comprises a Microsoft Windows environment, SNMP whenever the technology element comprises a network device, SQL whenever the technology element comprises a database and native O/S commands whenever the technology element comprises a Unix or Linux environment.

43. The computer program as recited in claim 27, wherein the data repository further comprises key relationships between the technology elements for successfully completing a business process, customer mapping of the technology elements, functional relationships of the technology elements, key performance indicators, auto correction rules based on event logic, escalation rules or a combination thereof.

44. The computer program as recited in claim 27, wherein the data repository includes a unique device identification, a device name, a device type and a device data model for each technology element.

45. The computer program as recited in claim 27, further comprising:
a code segment for automatically discovering and configuring the technology infrastructure;
a code segment for automatically setting up a customer specific alert generator; or
a code segment for automatically setting up a technology specific alert generator.

46. An apparatus for outsourcing management of one or more technology infrastructures having two or more technology elements, the apparatus comprising:
a data repository having one or more rules for managing and interfacing with two or more technology elements and a metadata dictionary;
a communications interface;
one or more processors communicably coupled to the data repository and the communications interface wherein the one or more processors are configured to collect data from the technology elements via the communications interface using the interface rules and metadata dictionary, analyze the collected data, and initiate one or more automated processes based on the analyzed data, one or more thresholds and the management rules; and
each technology infrastructure belongs to a separate entity and is remotely located with respect to a management entity.

47. The apparatus as recited in claim 46, wherein the communications interface comprises one or more collectors.

48. The apparatus as recited in claim 46, wherein the one or more processors comprise an analyzer.

49. The apparatus as recited in claim 46, further comprising an input application program interface, an output application program interface, or a combined input/output application program interface.

50. The apparatus as recited in claim 46, wherein the technology elements comprise one or more computers, one or more laptops, one or more workstations, one or more processors, one or more servers, one or more communication devices, one or more network devices, one or more switches/routers, one or more security devices, one or more applications, one or more business processes, one or more utilities, one or more data backup/recovery processes or devices, one or more databases, one or more operating systems or a combination thereof.

51. The apparatus as recited in claim 46, wherein the automated processes comprise correcting the technology elements, troubleshooting the technology elements, detecting and interfacing with one or more new technology elements, detecting one or more changes in the technology elements, correcting detected defects, correcting detected problems, reporting alerts, reporting warnings, reporting errors, reporting statistics, reporting a status of the technology elements, generating customer specific reports, maintaining the technology elements, updating the technology elements, providing one or more notifications, creating one or more audit trails, creating one or more security logs, monitoring security of the technology elements or a combination thereof.

52. The apparatus as recited in claim 46, wherein the management entity manages the technology infrastructure at a price that is less than a cost for the separate entity to manage the technology infrastructure.

53. The apparatus as recited in claim 52, wherein the price is less than or equal to 70% of the cost.

54. The apparatus as recited in claim 52, wherein the price is 40% to 70% of the cost.

55. The apparatus as recited in claim 46, wherein the management entity only manages a portion of the technology infrastructure.

56. The apparatus as recited in claim 55, wherein the managed portion of the technology infrastructure comprises one or more legacy technology elements, one or more splintered technology elements, one or more specialized technology elements, one or more small-scale technology element or a combination thereof.

57. The apparatus as recited in claim 46, wherein the apparatus improves a reliability and a performance of the technology infrastructure, reduces the cost to the separate entity, reduces a number of employees required by the separate entity or a combination thereof.

58. The apparatus as recited in claim 46, wherein the data repository, analyzed data, the thresholds, the management rules, the interface rules or a combination thereof are accessible via a web-based browser.

59. The apparatus as recited in claim 46, wherein the thresholds are defined based on one or more characteristics of the technology elements.

60. The apparatus as recited in claim 46, wherein the processors are configured to dynamically configure the technology elements based on the interface rules, the metadata dictionary, the management rules or a combination thereof.

61. The apparatus as recited in claim 46, wherein the data repository further comprises key relationships between the technology elements for successfully completing a business process, customer mapping of the technology elements, functional relationships of the technology elements, key performance indicators, auto correction rules based on event logic, escalation rules or a combination thereof.

62. The apparatus as recited in claim 46, wherein the data repository includes a unique device identification, a device name, a device type and a device data model for each technology element.

63. A system for outsourcing management of one or more technology infrastructures comprising:
each technology infrastructure having two or more technology elements belonging to a separate entity and is remotely located with respect to a management entity;
a communications network;
a server communicably coupled to the two or more technology elements via the communications network wherein the server comprises a data repository, a communications interface and one or more processors communicably coupled to the data repository and the communications interface;
the data repository having one or more rules for managing and interfacing with two or more technology elements and a metadata dictionary; and
the one or more processors are configured to collect data from the technology elements via the communications interface using the interface rules and the metadata dictionary, analyze the collected data, and initiate one or more automated processes based on the analyzed data, one or more thresholds and the management rules.

64. The system as recited in claim 63, wherein the communications interface comprises one or more collectors.

65. The system as recited in claim 63, wherein the one or more processors comprise an analyzer.

66. The system as recited in claim 63, further comprising an input application program interface, an output application program interface, or a combined input/output application program interface.

67. The system as recited in claim 63, wherein the technology elements comprise one or more computers, one or more laptops, one or more workstations, one or more processors, one or more servers, one or more communication devices, one or more network devices, one or more switches/routers, one or more security devices, one or more applications, one or more business processes, one or more utilities, one or more data backup/recovery processes or devices, one or more databases, one or more operating systems or a combination thereof.

68. The system as recited in claim 63, wherein the automated processes comprise correcting the technology elements, troubleshooting the technology elements, detecting and interfacing with one or more new technology elements, detecting one or more changes in the technology elements, correcting detected defects, correcting detected problems, reporting alerts, reporting warnings, reporting errors, reporting statistics, reporting a status of the technology elements, generating customer specific reports, maintaining the technology elements, updating the technology elements, providing one or more notifications, creating one or more audit trails, creating one or more security logs, monitoring security of the technology elements or a combination thereof.

69. The system as recited in claim 63, wherein the management entity manages the technology infrastructure at a price that is less than a cost for the separate entity to manage the technology infrastructure.

70. The system as recited in claim 69, wherein the price is less than or equal to 70% of the cost.

71. The system as recited in claim 69, wherein the price is 40% to 70% of the cost.

72. The system as recited in claim 63, wherein the management entity only manages a portion of the technology infrastructure.

73. The system as recited in claim 72, wherein the managed portion of the technology infrastructure comprises one or more legacy technology elements, one or more splintered technology elements, one or more specialized technology elements, one or more small-scale technology element or a combination thereof.

74. The system as recited in claim 63, wherein the system improves a reliability and a performance of the technology infrastructure, reduces the cost to the separate entity, reduces a number of employees required by the separate entity or a combination thereof.

75. The system as recited in claim 63, wherein the data repository, analyzed data, the thresholds, the management rules, the interface rules or a combination thereof are accessible via a web-based browser.

76. The system as recited in claim 63, wherein the thresholds are defined based on one or more characteristics of the technology elements.

77. The system as recited in claim 63, wherein the processors are configured to dynamically configure the technology elements based on the interface rules, the metadata dictionary, the management rules or a combination thereof.

78. The system as recited in claim 63, wherein the data repository further comprises key relationships between the technology elements for successfully completing a business process, customer mapping of the technology elements, functional relationships of the technology elements, key performance indicators, auto correction rules based on event logic, escalation rules or a combination thereof.

79. The system as recited in claim 63, wherein the data repository includes a unique device identification, a device name, a device type and a device data model for each technology element.
